(19) United States
(12) Patent Application Publication
(10) Pub. No.: US 2004/0144019 A1
(43) Pub. Date: Jul. 29, 2004

(54) High pressure extraction

(76) Inventors: Donald James Nicklin, Closeburne, Queensland (AU); Peter James Tait, Tarragindi, Queensland (AU)

Correspondence Address: BIRCH STEWART KOLASCH & BIRCH, PO BOX 747, FALLS CHURCH, VA, 22040-0747, US

(21) Appl. No.: 10/479,755

(22) PCT Filed: Jun. 4, 2002
(86) PCT No.: PCT/AU02/00714

(30) Foreign Application Priority Data
Jun. 4, 2001 (AU) PR5446

(51) Int. Cl. E21C 41/00; B01J 10/00; C10L 5/00

(52) U.S. Cl. 44/626; 422/129; 299/3

(57) ABSTRACT

A reactor system comprising two or more subterranean reactors for high pressure treatment of materials. The reactors each comprise an inlet tube, a reaction region and an out let tube and are deep enough for material in the inlet and outlet tubes to produce signifecant hydrostatic pressure. The reactors are adapted to exchange heat which may occur through a shared heat transferring wall or a heat exchanger including circulating liquid. The invention also extends to a method of simultaneously running two processes in the reactor system. The preferred processes are hydrothermal dewatering of coal, especially brown coal, and coal liquefaction wherein exothermic heat product of one process contributes to the heating requirements of the other process. The invention also extends to a method of hydrothermal dewatering of coal when conducted in a subterranean reactor in conditions of decreasing pressure.

### FIELD OF THE INVENTION

This invention relates to reactors for chemical reactions. In particular the invention relates to reactors formed in bore holes thereby providing an environment in which high pressure may be generated and thermal efficiency may be maximised in comparatively safe conditions.

### BACKGROUND OF THE INVENTION

Many processes require slurries of material to be processed under elevated temperature conditions. Many of these processes involve at least one solid reagent which is slurried in a suitable fluid or solvent, often water, for processing.

Because it is generally desirable to limit the loss of the solvent by evaporation, the operations are carried out under a pressure such that the solvent will not evaporate.

Typical examples of such processes are the oxidative leaching of lateritic nickel ores, digestion of bauxite in Bayer Process plants, super-critical solvent extraction of coal, the hydro-liquefaction of coal and the hydro-thermal dewatering of brown coal.

These processes are commonly carried out in surface mounted pressure vessels. The pressure conditions encountered are typically up to 60 bar, but can be much higher for super-critical operations (eg +220 bar for supercritical water). Temperatures for many processes are ideally carried out in the range 100 to 200° C., but sometimes desired operating temperatures can be 300° C. or higher.

In many plants, the operating pressure of the high pressure operation is a trade off between the rapidly increasing capital and operating cost in going to higher pressure operations against the more desirable process results (eg better leaching kinetics, more rapid reaction, better extraction).

Some reaction vessels have such thick vessel walls to contain the pressure that they end up being made of clad material. For example, if titanium metal is required in contact with the process fluid, there will be a vessel wall thickness above which it is economic to switch from simply titanium plate across to steel clad in titanium. The use of either thick exotic materials or specialised construction techniques such as the use of clad plate, substantially add to the complexity and cost of such pressure vessels.

There is also an issue of safety. Having very high pressure vessels with aggressive process fluids leads to the prospect of vessel failure with serious personnel and property safety ramifications.

Generally, the surface mounted pressure vessel/s to perform these operations have high pressure feed pumps. For slurries, these can be quite complicated. For modest pressures, one or more centrifugal pumps can be used in series, but for very high pressures, special pumps are required and are extremely expensive. An additional deficiency then arises in that these very high pressure pumps, such as piston, diaphragm or plunger pumps, often limit the upper size of particles that may be handled.

It has been reported in U.S. Pat. No. 3,606,999 (“Lawless”) that solid liquids and gases may be contacted at elevated pressures and desired temperatures by forming a reaction vessel at a depth suitable to use hydrostatic pressure in a delivery pipe. A single reaction vessel is described which, in one form, is a hydraulic equivalent of a U-tube mounted in a vertical passage. A method of transferring heat from outlet to inlet liquids is also described in which an inlet pipe is located in contact with an outlet stream. The arrangement of Lawless can only be used for a single reaction process at any one time.

### SUMMARY OF THE INVENTION

Unless the context clearly requires otherwise, throughout the description and the claims, the words “comprising”, and the like are to be construed in an inclusive sense as opposed to an exclusive or exhaustive sense, that is to say, in the sense of “including, but not limited to”.

In a first broad aspect, the invention resides in a process arrangement for treating one or more materials, the arrangement comprising one or more vessels located beneath a surface of the ground, the one or more vessels adapted to receive the one or more materials or part thereof. The one or more vessels include a reaction zone, entry means for feeding at least one of the materials to the reaction zone and exit means for retrieving treated material from the reaction zone.

At least one vessel extends to a depth below the surface sufficient to generate pressure from a hydrostatic head in the entry and/or exit means and the entry means comprises at least two tubes.

The process arrangement may comprise two or more vessels located beneath a surface of the ground with each vessel adapted to receive at least one material. The vessels may include a reaction zone, entry means for feeding at least one of the materials to the respective reaction zone and exit means for retrieving treated material from the reaction zone.

At least two of the vessels may extend to a depth below the surface sufficient to generate pressure from a hydrostatic head in the entry and/or exit means and at least two of the vessels may be adapted for theirnal exchange therebetween.

At least two of vessels may have an entry means comprising at least two tubes.

The process arrangement may have at least one vessel with an entry means comprising an array of tubes having 7 or more tubes.

The process arrangement may have an entry means comprising an array of tubes having 20 or more tubes.

The process arrangement may have at least one of the vessels with an entry means comprising an array of tubes having between 50 and 200 tubes.

The process arrangement may have at least of the vessels with an entry means comprising an array of tubes having more than 200 tubes.

The process arrangement may have one or more of the vessels extending at least 100 metres below the surface of the ground, preferably, at least 500 metres.

The entry means of at least one vessel may be formed as continuous tubes with, optionally one or more of the continuous tubes having at least part of their side walls formed by rock.

The continuous tubes may be formed by interconnected metallic tubular sections.

The tubes may have a diameter in the range of 250 mm to 100 mm, preferably around 50 mm.

The entry means may connect the reaction zone to the surface of the ground.

The exit means of at least one vessel may be formed as a continuous exit tube.

The exit tube may have at least part of its side walls formed by rock.

The exit means may be formed by interconnected tubular sections.

One or more exit means may connect the reaction zone to the surface of the ground.

The exit means of at least one vessel may include one or more gas collectors.

The exit means of at least one vessel may include a choking valve to control the back pressure on the treated material.

The entry means and exit means may be formed in a downwardly directed bore, which may be substantially vertical.

At least two vessels may be in heat exchanging proximity to each other.

The two vessels may be adapted for thermal exchange therebetween through heat exchange means.

The heat exchange means may be a heat transferring wall section common to at least two vessels.

Alternatively, the heat exchange means may comprise a liquid located in a circulation system wherein the liquid is circulated into heat exchanging contact with at least two vessels.

The process arrangement may further comprise an access shaft adapted to provide access below the surface of the ground to at least one vessel.

In a further aspect, the invention may reside in a reactor assembly comprising at least two reaction chambers each formed with an inlet means for delivering process materials to a reaction zone, an outlet means for retrieving treated process materials or their products from the reaction zone wherein the inlet means and outlet means are located in downwardly extending subterranean passages, at least two of the reaction chambers are adapted for thermal exchange therebetween and the inlet means comprises an array of 2 or more tubes, preferably 50 or more tubes.

One or more of the reactor chambers may be formed with an extended U shaped configuration.

One of the reaction chambers may be located substantially within the confines of at least one other of the reaction chambers.

The reaction chambers may be adapted for thermal exchange through heat exchange means.

The heat exchange means.may comprise a circulation system for circulating a heat conducting liquid into heat exchanging contact with at least two reaction chambers.

The reactor assembly may further comprise one or more subterranean communication channels providing a pathway for fluid in an outlet means of one reaction chamber to transfer to an inlet means of another reaction chamber.

In another aspect, the invention resides in a method of conducting two processes under pressurised conditions comprising the steps of:

introducing materials for a first process into a first reactor located substantially underground and formed by a downwardly extending inlet tube communicating with a processing zone, said processing zone communicating with an upwardly extending outlet tube arrangement;

introducing further materials for a second process into a second reactor located substantially underground and formed by a downwardly extending inlet tube communicating with a processing zone, said processing zone communicating with an upwardly extending outlet tube arrangement,

initiating the first and second processes; and

transferring heat between the reactors wherein one of the processes is hydrothermal dewatering of coal.

The other of the processes may be coal liquefaction. Coal which has undergone hydrothermal dewatering in the first process may be subject to liquefaction in the second process.

In still a further aspect, the invention resides in a method of hydrothermal dewatedng of coal in an underground reactor comprising one or more delivery tubes communicating with a reaction chamber which in turn communicates with one or more exit tubes, the method comprising the steps of:

delivering a coal slurry through the one or more delivery tubes to the reaction zone; and

initiating the hydrothermal dewatering process such that the process occurs substantially in conditions of decreasing pressure as the material rses in the one or more exit tubes.

The method may further include the step of:

maintaining an. upward directed flow of the slurry substantially throughout hydrothermal dewatering of the coal.

The velocity of material may be controlled by pump pressure.

The upward directed flow of the slurry may be maintained throughout hydrothermal dewatering of at least 50% of the coal.

The velocity of the slurry may be in the range of 0.5 metre per second to 3 metres per second, preferably around 1 metre per second.

A concentration of coal in the slurry may be selected to control the heat production of the reaction and thereby control the temperature in the reaction zone.

The concentration of as mined coal in the slurry is between 40% weight percentage and 65% weight percentage, preferably around 50% weight percentage. The coal may be brown coal.

In a further aspect, the invention resides in a process arrangement for treating one or more materials, the arrangement comprising two or more vessels located beneath a surface of the ground to contain at least one of the one or more materials, the two or more vessels each including a reaction zone, entry means for feeding the at least one material to the reaction zone and exit means for retrieving material after it has been treated, wherein the vessels extend to a depth below the surface sufficient to generate a significant pressure from a hydrostatic head In the entry and/or exit means and at least two of the vessels are adapted for thermal exchange therebetween. Treating may include applying pressure and/or heat to the one or more materials.

The at least one material preferably comprises a different material or combination of materials for each of at least two vessels. The vessels may extend to any suitable distance below the ground surface but are preferably 100 metres or more below ground surface. The vessels may preferably extend 500 m or more below the ground surface. The at least one material may include coal.

The entry means may be formed as a continuous tube. The entry tube may be formed with at least part of its side walls formed by rock. The entry tube may be formed with at least part of its side walls formed by interconnected tubular sections, preferably metallic. Preferably the entry tube connects the reaction zone to the surface. Preferably the entry means is formed as a tube array comprising two or more continuous tubes. The two or more tubes may be parallel and may be connected to each other. In a preferred embodiment the tube array may comprise 100 or more tubes. The diameter of each tube may preferably be around 5 centimetres.

The exit means may be formed as a continuous exit tube. The exit tube may be formed with at least part of its side walls formed by rock. The exit tube may be formed with at least part of its side walls formed from metal, preferably as interconnected tubular sections. Preferably, the exit means connects the reaction zone to the surface. The exit means may comprise a tube array including two or more tubes. The two or more tubes may be parallel to each other. The tube array may comprise 100 or more tubes. The diameter of the tubes may be around 5 cm.

The entry means and exit means may be formed in at least one downwardly directed bore, preferably vertical. At least two vessels may be adapted for thermal exchange by location of at least part of the two vessels in heat exchanging proximity to each other. The vessels may share at least one common, heat transferring wall section which may be metallic. The heat transferring wall section may be located in the reaction zone of each of the at least two vessels but will typically occur associated with the regenerative heating step and may be outside the reaction zone.

Alternatively, the vessels may be adapted for heat transfer through a heat exchange means. The heat exchange means may comprise a liquid located in a circulation system, wherein the liquid is circulated from heat exchanging contact with a first vessel, to heat exchanging contact with a second vessel. The section of the respective vessels placed in contact may be any suitable sections such as reaction region and reaction region, entry tube and reaction region, or entry tube and exit tube.

The process arrangement may further comprise an access shaft adapted to provide access to at least one vessel. The process arrangement may comprise three or more reaction vessels. The 3 or more reaction vessels may be located around an access shaft formed to provide access to the vessels, especially at depth.

In a second aspect, the invention resides in a reactor assembly comprising at least 2 reaction chambers each formed with an inlet means for delivering reaction materials to a reaction zone and outlet means for retrieving treated reaction materials from the reaction zone wherein the inlet means and outlet means are formed in downwardly extending subterranean passages and at least two of the reaction chambers are adapted for thermal exchange there between.

One or more of reaction chambers may be formed as an extended U-shaped configuration. At least two of the reaction chambers may share a common, heat transferring wall section. At least one of the reaction chambers may be located substantially within the confines of at least one other of the reaction chambers.

In a third aspect, the invention resides in a method of conducting two processes requiring pressurised conditions, the method comprising the steps of:

introducing. materials for a first process into a first reactor located substantially underground and formed by a downwardly descending inlet tube arrangement, a process zone and an upwardly extending outlet tube arrangement;

introducing further materials for a second process into a second reactor located substantially underground and formed by a downwardly descending inlet tube, a process zone and an upwardly extending outlet tube arrangement;

initiating the first and second processes; and

transferring heat between the reactors.

The tube arrangement may include a single tube arrangement or a plurality of tubes, preferably arranged in parallel.

Initiating the first and second process may include the step of applying heat to at least one of the reactors. Preferably the first process is hydrothermal dewatering of coal, especially brown coal. The second process may suitably comprise coal liquefaction. In a preferred embodiment, coal which has undergone hydrothermal dewatering in a first reactor is subject to liquefaction in the second reactor.

In an alternative aspect, a reaction vessel or reaction chamber includes one or more boreholes used to conduct at least a portion of a process underground. By this means, the fluid or slurry to be processed is pumped underground to a depth sufficient to generate a suitable pressure at which to conduct the desired process. The design of the borehole and underground facilities are such that preferably a major portion (>50%) of the pressure is generated by hydrostatic forces. It is a further option to provide for heat exchange between the fluid/s entering and leaving, between fluids and utility streams for either heating or cooling and with the ground material into which the borehole(s) are sunk. This heat exchange can be for the purposes of energy recovery, heating or cooling or to draw thermal energy from the surrounds.

In its simplest form, a vessel may include a single borehole with concentrically mounted pipes. An inner pipe might be used to convey the fluid down to the base of the borehole with the outer annulus used to convey the fluid back. Because a common wall separates the two fluids, heat exchange is obtained between the feed mixture being pressurised during its trip to the high pressure zone at the bottom of the bore and the fluid returning to the surface after being to the high pressure zone. This heat exchange can be used advantageously in most processes. In a preferred embodiment, the inner pipe arrangement comprises two or more pipes for delivery of material. The two or more pipes provide an increased surface contact area for the transfer of heat from exiting material to incoming material thereby producing increased efficiency in heat transfer. The two or more pipes may be connected to each other or alternatively stand alone. Sometimes, the process needs to be heated or cooled in the high pressure zone. This heat can be provided by many ways such as electrically, chemically, in indirect heat transfer with, for example, steam or direct heat transfer with steam or another fluid.

Chemical processes or reactions may be carried out in the high pressure zone. Additionally, other reactants may need to be added to the high pressure zone in order to achieve the desired reaction conditions. These reactants may include oxygen, hydrogen or the like. One variation is to inject gaseous reactants at a depth below the surface where sufficient pressure is established such that the bubble size of the gas once injected into the fluid, is sufficiently small that it can be swept down to greater depths by the velocity of the fluid. This saves having to compress the gas to the ultimate pressure required in the high pressure reaction zone and this helps save capital equipment for expensive gas compressor equipment.

In more complicated processing plants, a number of boreholes and underground caverns or pressure vessels may be used to perform complicated processing operations. The key feature in these processing plants is that gravity has been used for a substantial portion of the pressurising required. Furthermore, pressure recovery may also be achieved in returning material to the surface.

The physical means by which the underground processing facility is formed by a combination of drilling holes and for at least portions of the.length, using the parent rock material as the “vessel”. Other options including lining the hole with a thin walled pipe which is hydraulically deformed to occupy much of the original hole diameter by the forces of the fluid column, the installation of thick walled pipe in areas where the parentrock is not suitable, and the electro-deposition of metallic liners into the drilled rock. It is envisaged that the underground processing facility could consist of a number of interconnecting holes and pipes with expanded sections for vessels, heat exchanger sections and other functional geometries. It is also possible that the facilities are not only accessed from the surface. For example, it may be convenient. to install the underground facilities adjacent to mining access tunnels or a central service bore to allow the provision of utilities, specialised equipment or instrumentation to selected portions of the processing equipment. At one extreme, the main pressure vessel that would have been used on the surface is placed underground and the piping from the surface down and back up is used largely to achieve the pressurisation and possibly the heat interchange. Thus, the underground environment assists to resolve pumping difficulties and potentially heat recovery issues. The preferred embodiment is for the processing apparatus to undertake at least a portion of the processing as this has capital cost advantages.

It is possible to add additional components to the feed fluid mixture to facilitate reaction. One example is to add a catalyst to assist in the desired reaction/s.

In still another aspect the present invention provides a method of physically and/or chemically altering a material comprising providing said material to a predetermined location underground at which a desired pressure and/or heat is applied, maintaining said material at said location for a period sufficient to physically and/or chemically alter said material, and retrieving said altered material from said location.

As will be known by those skilled in the art, the pressure and heat applied may not all come from the underground location. Some “artificial” boosting of the “natural” pressure and/or heat may be provided. For instance, the total pressure applied to the material can be a combination of the hydrostatic pressure applied by the column of material entering or leaving the vessel, the air/ground pressure at that location, and any additional “artificial” pressure boosting or relief.

In another aspect, the invention resides in a method of hydrothermal dewatering of coal in an underground reactor comprising one or more delivery tubes communicating with a reaction chamber which in turn communicates with one or more exit tubes, the method comprising the steps of:

delivering a coal slurry through the delivery tube or tubes to the reaction zone;

initiating the hydrothermal dewatering process;

wherein:

the hydrothermal dewatering process occurs substantially in conditions of decreasing pressure as the material rises in the one or more exit tubes.

The coal is preferably brown coal. Substantially in this regard may mean at least 50% of the reaction occurring in conditions of decreasing pressure. The method may include the step of controlling the velocity of material at between 0.5 to 3.0 metres per second and preferably at around 1 metre per second. The method may include varying the concentration of coal in the slurry between 40% weight percentage coal as mined and 65% weight percentage of coal as mined. Preferably, the coal percentage is around 50% weight percentage.

### BRIEF DESCRIPTION OF THE DRAWINGS

FIG. 1 is a schematic sectional view of an arrangement of a subterranean reactor.

FIG. 2 is a schematic sectional view of two subterranean reactors arranged in co-operative working relationship.

FIG. 3 is a schematic sectional view of two subterranean reactors and associated apparatus for treatment of coal.

FIG. 4 is a schematic sectional view of two subterranean reactors and interconnected heat transfer system.

FIG. 5 is a top view of an arrangement of subterranean reactors.

### DETAILED DESCRIPTION OF THE DRAWINGS

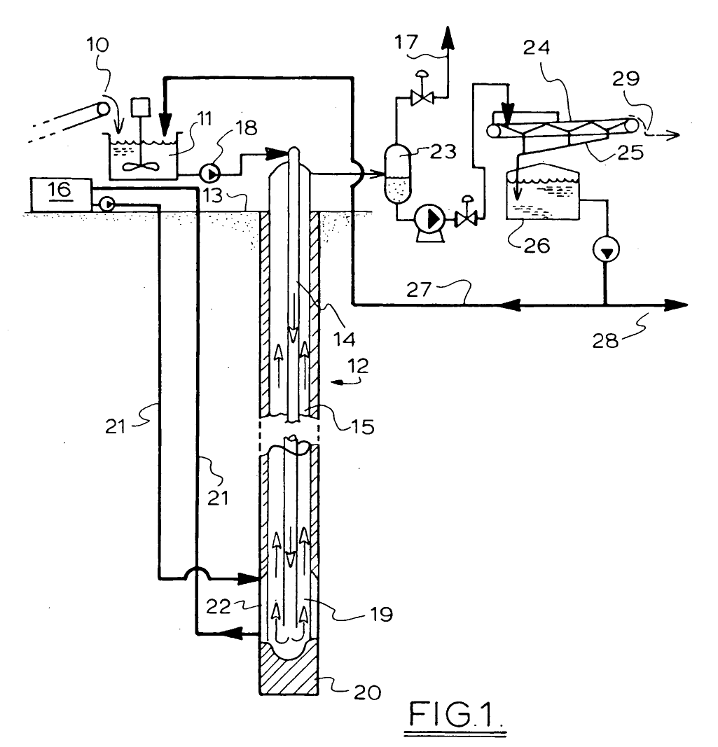

By way of clarification, an example of the technology, in which brown coal can be hydro-thermally dewatered in a reaction vessel or reaction chamber will now be discussed with reference to FIG. 1. This process is not known to be widely commercialised which is considered largely due to the difficulty in performing this operation with surface mounted equipment—especially the feed pressurisation and product release mechanism. This process is the subject of expired Australian Patent Number 430626. This patent describes the characteristic of brown coal (and other organic materials) whereby upon application of pressure with temperature, the material characteristic of the coal changes. The coal is physically/chemically altered and water is expelled from the coal without the need for evaporation.

Certain types of brown coal may contain up to 70% by weight of water. Brown coal may be understood to include sub-bituminous coal, lignite and unconsolidated brown coal. At high temperature and pressure and in the presence of water, coal loses a significant percentage of unbound water and undergoes changes that prevent complete reabsorption of water. This process may also generate CO₂. Heat treatment may be carried out at any suitable range but preferably above 200°C.

It is firstly desired to slurry brown coal delivered by conveyor 10 in water 11 which may be recycled process water and to pressurise and heat this to a temperature of around 250° C. or higher to bring about an irreversible altering of the coal. In order to avoid vaporisation of water, the pressure should be kept above the vapour pressure of water at the selected temperature. At all locations along the reactor flow path, as temperature of the material increases, the pressure may also increase. In this case, the ultimate pressure reached would be at least 40 bar for 250° C. and correspondingly higher for higher temperatures. The referenced patent describes a mechanically and operationally complicated system with poor heat recovery comprising a pressurising screw extruder, a high pressure autoclave and a discharge device also consisting of a screw. The system is considered a compromise between the cost of the equipment (and the safety considerations) and the desire to operate at higher temperature (and hence pressure) in order to speed the kinetics of reaction.

When the same reaction is conducted according to the present invention, it is safe and convenient to operate to a higher temperature. For the purposes of this example, a temperature of 280° C. has been chosen. The hydro-thermal dewatering is known to proceed very rapidly under these conditions. To prevent water evaporating, the pressure should be at least 65 bar when the temperature is near 250° C. This is achieved by conducting the process according to the present invention in a piping arrangement forming a reactor or reaction vessel 12 that extends at least 650 m down beneath the ground surface 13. Note that some flexibility exists to shorten the submerged length by providing back-pressure and/or elevated discharge piping at the surface.

By the time frictional pressure drops and the increased density of a coal/water slurry are taken into account, the fluid is at all times above its saturation pressure for the entire path from surface slurrying facilities, through the centrifugal feed pump, through the underground reactor, back to the surface and through the product discharge arrangement.

The pipes to conduct the process consist of two relatively thin walled pipes mounted concentrically. The slurry mixture flows down to the bottom of the borehole via the inner pipe 14 and back via the annulus 15. Heating is provided to initiate the reaction and to maintain the operating conditions if required. This can be via an electric heater near the base of the process or by any other means (eg a separate hot oil or liquid metal circuit 16). Note that brown coal thermal dewatering is unusual in that the reaction that takes place is slightly exothermic with the release of some carbon dioxide 17. If properly designed, it should be possible to have the reaction self-supporting by achieving most (if not all) of the thermal heat requirements by the heat released from the process. A plurality of smaller diameter inner pipes can be used to increase the surface area for heat transfer and external heat transfer equipment can also be provided if required.

The slurry is delivered to the inner pipe 14 by pump 18. As the slurry descends down pipe 14, heat transfer occurs through the wall of pipe 14, which may be any suitable conducting material with adequate strength characteristics. Preferably the wall is metal. The slurry descends with increasing pressure to a reaction zone 19 where adequate temperature and pressure are attained for the desired process. The reaction zone 19 and the reaction vessel 12 may be supported by concrete reinforcement 20 although this is not essential. The reaction zone may include sections of the inner pipe and/or the annulus 15 as initiating conditions may be attained during the descent of the material and acquiring heat. The reaction may also continue through the lowermost section of the reaction zone and at least part way up the exit means in the form of the annulus 15.

Heat is effectively supplemented by hot oil delivered from heating system 16, through pipes 21 to heat exchanger 22. The treated material then flows up the annulus 15, allowing for heat transfer back into the delivered material in the pipe 14.

Treated material is delivered to a separator 23 which facilitates discharge of carbon dioxide 17. The treated slurry is delivered to a conveyor 24 which is formed to allow drainage of excess water onto collecting surface 25 and subsequent containment in tank 26. Some water is recycled through line 27 and excess water is forwarded for treatment 28 prior to discharge. Processed coal 29 is transported as required.

The above process may be particularly beneficial as, with selection of suitable conditions, it will produce high quality, low porosity material from brown coal. A preferred temperature is in the range of 250-350° C., most preferred around 320° C. Treatment time at this level may be 5 minutes or more. In certain conditions the treatment time may be even less. Preferably the reactor is configured so that most of the heating over 250° C. is in a zone of decreasing pressure. Most commonly, this will occur in the exit tube where decreasing pressure is a product of the elevation of the material in the reactor. Controlling the reaction location such that coal particles that traverse the reaction zone do so in conditions of decreasing static pressure may result in a denser, drier product with decreased intraparticle porosity. A preferred velocity for the material is around 1 metre per second in downward and upward flow. One benefit of this velocity is that frictional pressure drop is relatively easily met by conventional centrifuge pumps, although a number connected in series may be advantageously used. A preferred range for the velocity is 0.5 to 3 metres per second. A further control aspect of the process arises from the capacity to vary the concentration of coal in the slurry. By decreasing the concentration, the temperature rise in the slurry may be decreased. This provides a means of manipulating the thermal conditions in the reaction zone. The high cost and high energy input of surface systems are avoided with the present system providing the ability to generally operate at a steady, controlled, cost and energy effective manner.

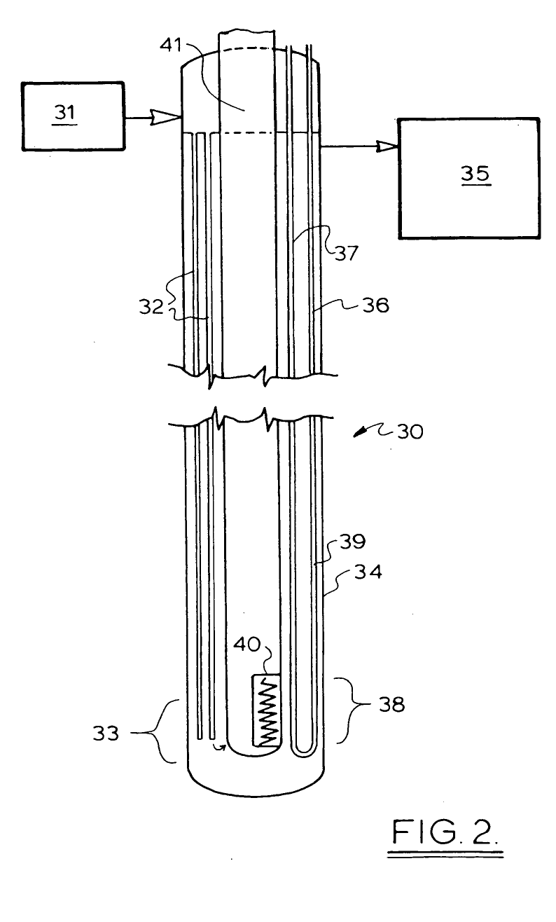

FIG. 2 shows a schematic representation of two combined reactors indicated generally as 30. Coal slurry 31 is delivered to an inlet means in the form of inlet tubes 32 and descends under the effect of gravity and pumping towards reaction zone 33. While this schematic representation discloses two inlet tubes it should be appreciated that effective heat transfer may best arise from an array of tubes of up to 100 to 200 in number, or any other suitable number. The number of tubes will vary with the amount of heat required and can be calculated using heat exchange equations as needed. If, for example, larger diameter tubes are used, the inlet tube may be taken deeper to provide an increased opportunity for heat transfer. An operator may choose to add the effect of a pump to the pressure delivery column in tubes 32 to enhance the pressure effect of the inlet supply. The decarboxylation reaction that occurs during hydrothermal dewatering is exothermic and provides the capacity to produce at least some and potentially all of the temperature lift required in the base of the reactor. It may be necessary to provide start-up heat and boost heat generation during operation. The use of appropriate heat supply devices or systems is well known to a person skilled in the area. Treated coal slurry then rises in the outlet means in the form of outlet tube or chamber 34 resulting in a discharge of hydrothermally dewatered coal slurry 35 which may be further treated for recovery. The outer tube 34 may be formed with a cross sectional shape of two spaced concentric circles, the inner most located around a central utility access bore 41.

A second reaction chamber or vessel 36 is formed by a second inlet tube 37, second reaction zone 38 and second outlet tube 39.

The second reaction chamber is located to provide suitable heat transfer between the contents of the reaction zone 38 of the first reaction vessel or reactor and the contents of the second reaction vessel or reactor. Clearly heat transfer may also occur during the passage of material down second inlet tube 37. An auxiliary heat source 40 may also be provided to supply heat to the first reaction chamber and/or to the second reaction chamber. In a preferred process, the second reaction chamber 36 is used for hydroliquefaction of coal. This process produces substances such as gasoline and light oil from coal as a result of decomposing coal preferably under high-pressure hydrogen and in moderate temperatures (which may be around 350° C. to 470° C.) thereby producing oil which is a mixture of low molecular weight aromatic and aliphatic hydrocarbons. The liquefaction reactivity of coal is highly dependent on the type of coal. The yield of oil and other products vary with coal composition.

In the present arrangement the exothermic reaction of hydrothermal dewatering of coal produces heat which may be insufficient to totally power the process. Heat may therefore be harnessed from the exothermic coal liquefaction process providing a substantially closed, self sustaining system and simultaneous conduct of two independent processes. Combination of hydrothermal dewatering of coal and coal liquefaction therefor produces an efficient, co-operative interaction of the two working reactors to provide a beneficial outcome. The use of the cooperating deep reactors enables generation of high pressures safely as well as thermally efficient use of heat. The long flow paths provide for a reactor system which is largely plug flow.

The arrangement of FIG. 2 also discloses a central utilities access bore 41 which facilitates construction and maintenance of the reactors. Such an arrangement may facilitate supply of utilities and monitoring equipment access.

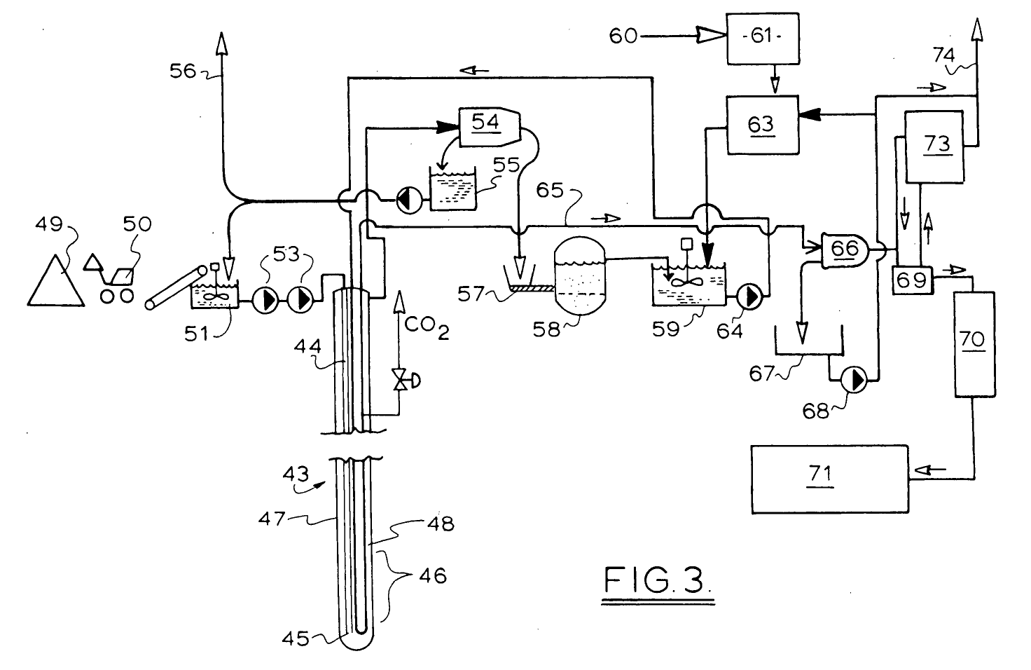

FIG. 3 is a schematic representation of an alternative arrangement of co-operating reactors in which a first reactor 43 is formed with a relatively narrow inlet tube 44 discharging through lowermost aperture 45 into reaction zone 46. The introduced material flows through the reaction zone. 46 before rising up outlet annulus or chamber 47.

The second reactor may of course be any suitable shape and indeed, several reactors may be located within the confines of the first reactor.

In operation, coal is collected from a stockpile 49 by any suitable mechanical device 50 and transferred to a tank 51 to mix with water to form a slurry. Pumps 53 transfer the slurry to the inlet tube 44 to travel through the first reactor. The treated material in the form of hydrothermally dewatered coal slurry is discharged from the reactor and transferred to a centrifuge 54 which separates the treated coal from water. Excess water is collected in the waste tank 55 and recycled to tank 51 and/or to waste 56.

Treated coal from the centrifuge 54 is delivered to a conveyor 57 to feed to a fluid bed drier 58. The dried coal may then be used for any suitable purpose.

In the present system, the dry coal is moved to a receiving tank 59 where it is prepared for hydroliquefaction processing. Natural gas 60 may be delivered to a hydrogen plant 61 to produce hydrogen gas which is used in a hydrogenation reactor 63 to hydrogenate a portion of the product oil to make it suitable for use as a hydrogen donor solvent. The hydrogen donor solvent is transferred to the receiving tank 59 for mixing with treated coal to form a slurry. A pump 64 transfers the slurry to the second reactor 48 where the mixture undergoes further pressurisation, preheating and liquefaction during passage through the reactor. The treated coal from the second reactor is transferred by line 65 to a second centrifuge 66 which separates liquid and solid components. The excess oil is separated and collected in an additional tank 67 before delivery by pump 68 to recycle and product oil 74. The solids from centrifuge 66 are washed with a suitable solvent in a washing stage 69. The washed solids are dried 70 and forwarded as combustible char to, for example, a power station 71.

Wash liquids are delivered to a separation unit 73 where the oil 74 is separated (eg. by distillation) and stored for use and recycled solvent is returned to the wash stage 69. This system provides a good example of a dual process reactor arrangement that provides important products of considerable value in a cost effective, thermally efficient and safe manner.

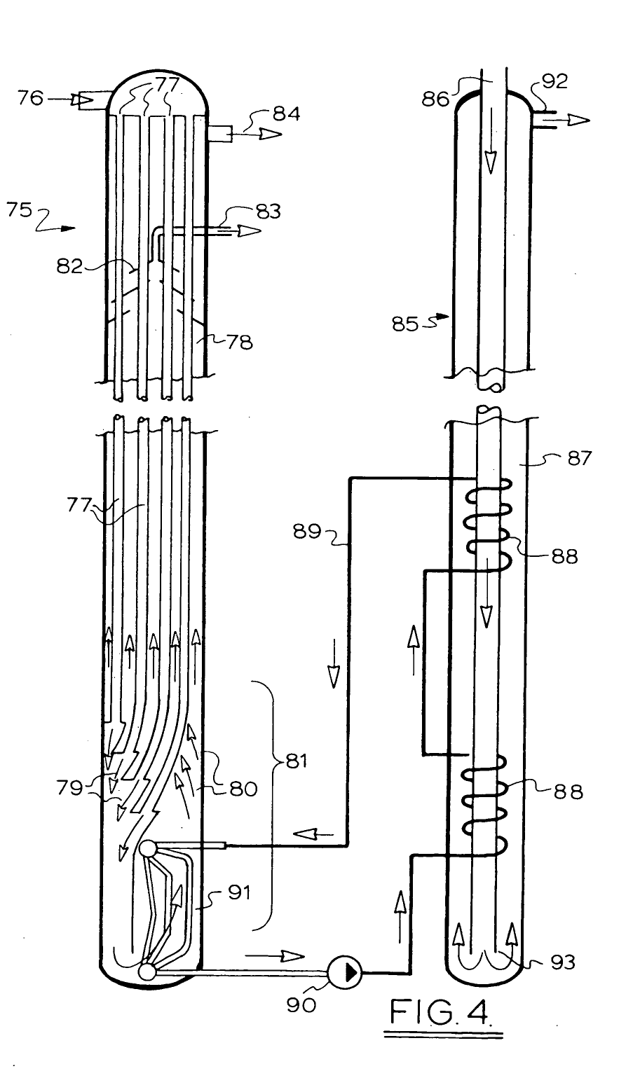

FIG. 4 is a schematic representation of two reactors in thermal exchange communication through heat transfer means. Again, reference will be made to the twin processes of hydrothermal dewatering and hydroliquefaction of coal. There is however no intention to limit the application of co-operating reactors to these applications.

A coal slurry is delivered to an inlet port 76 of a first reactor 75 and then into a plurality of descending inlet tubes 77 so chosen to provide the desired quantity of regenerative heat exchange while ensuring that, at all locations, the prevailing pressure exceeds the vapour pressure of the fluid. The slurry descends as a column down the tubes 77 providing hydrostatic pressure in the process and being heated through heat transferring walls, such as metal, from the ascending treated material in the outlet tube 78 which encloses the inlet tubes 77. The tubes may of course be any suitable shape to facilitate variations in rock and soil profiles. In one embodiment, the outer wall of one or more reactors may be formed by impervious rock, or treated sealed rock. Downwards arrows 79 show outfall of the material to be treated. Upward arrows 80 generally show the flow of treated material as it transits the reaction zone 81. The reaction zone is not a specifically defined region and is a term used to generally denote a zone in which initiating conditions of temperature are attained. It may include sections of the inlet and outlet tubes. The pressure increase is provided to ensure the vapour pressure of water is always exceeded to thereby prevent vaporisation. The actual pressure may exceed the vapour pressure by a factor of many times. These pressures may be attained by simply increasing the depth of the reactor and hence the hydrostatic head.

For processes that produce gas, one or more collectors 82 may be located in the outlet tube 78 to gather gas and direct it through a discharge line 83. Collectors may be located at a series of different depths in the reactor. In the present reaction, carbon dioxide may be formed and sequestered. It is preferred to have a series of collectors sited at various locations to facilitate the removal of gas thereby avoiding a bubbling effect as the surrounding pressure around highly pressurised gas bubbles decreases. As well as a safety aspect, this also provides for the sequestration of highly pure carbon dioxide which may be put to other industrial and commercial purposes. It may also be preferably to add one or more choking valves to the outlet means. This valve or valves may be used to control pressure in the outlet tube and hence, control pressure in the inlet tube. A pressure monitoring system may be provided in the outlet and inlet means. If gas production in the reaction zone decreases density of the material in the outlet means, a decrease in hydrostatic pressure in the inlet means may result and may produce an increased velocity as the denser inlet material produces a greater net flow pressure. If a pre-set limit of pressure in the inlet means is reached, the choking valve or valves may be activated to impact on the discharge velocity thereby maintaining the pressure in the system within preferred limits. This provides another mechanism for control of the process occurring in the system.

Treated material is discharged through outlet port 84. A second reactor 85 is shown having an inlet tube 86 located internally in an outer annulus forming the outlet tube 87.

Dry coal is slurried in a hydrogen donor fluid and delivered to the inlet tube 86. Hydroliquefaction is an exothermic reaction and heat produced may be harnessed and transferred by a heat transfer device. In FIG. 4, a first heat exchange arrangement 88 is located in the second reactor and sited at a suitable location.

Heat is transferred to a suitable fluid such as liquid sodium or heat transfer oil which is circulated around a circuit by a pump 90. The heat containing fluid is fed through a heat dispensing exchanger 91 to supplement heat generated in the reaction zone 81.

While the hydrothermal dewatering process is in itself exothermic, the energy requirements of a significant processing rate may not be adequately met by reliance on inherent heat generation. The harnessing of excess heat from another exothermic process may be of great benefit in maintaining the processing assembly in effective and productive operation.

Liquefied coal products are discharged from the outlet 92 of the second reactor 85 after discharge from the inlet tube 86 through lower opening 93 and flow up the annulus 87. Heat transfer between incoming and outgoing material may also be of considerable benefit. The desired heat exchange area may be achieved by using a multiplicity of tubes in parallel.

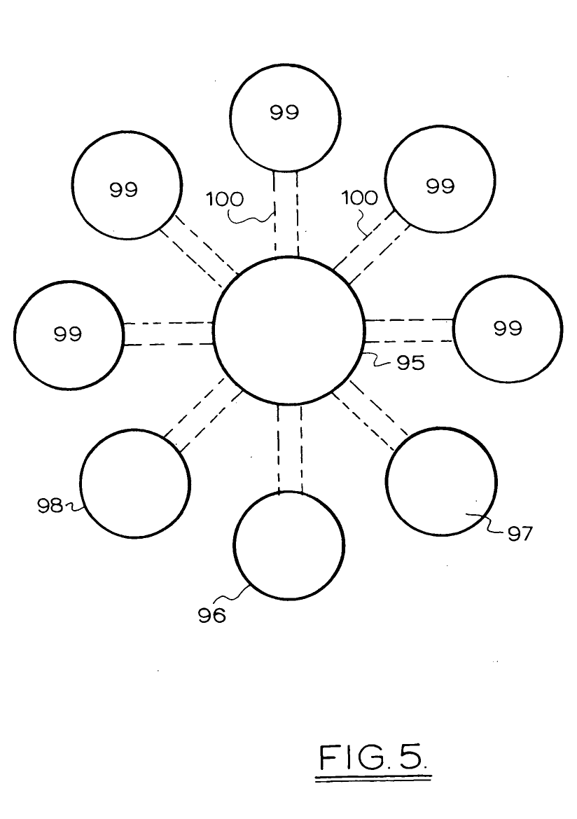

FIG. 5 is a top, schematic view of a group of reactors disposed around a central access shaft 95. Individual reactors are arranged as required. A reactor 96 is dedicated to hydroliquefaction of coal. Excess heat is conducted to a reactor 97 dedicated to hydrothermal dewatering by a heat transfer mechanism (not shown). A combined reactor 98 is also provided with a first and second reactor located in operating engagement. Further reactors 99 of the same or different arrangement are distributed around central shaft 95. Access through lateral shafts 100 (in hidden detail) which are formed at any convenient depth below the surface provide communication with the central access shaft 95.

One of the great advantages of the present invention is that physically mismatched reactors may be placed in working relationship with each other. That is, a deep, high pressure reactor may be placed in co-operative operation with a shallower, lower pressure device wherein the transfer of heat between the two may optimise the efficiency of the dual processes.

Although not shown, it is also possible to assemble a complex processing arrangement wherein sequential steps in a process are performed in interconnected reactors. Lateral communicating channels may be provided between an outlet tube of one reactor and an inlet tube of the next sequentially connected reactor. Such a communicating channel may be formed at a depth to retain materials at a required or preferred pressure. For example, hydrogen formed at pressure may be conveniently provided to another reactor rather than transporting it to the surface and attempting to repressurise or maintain its pressure for subsequent use. Adjacent reactors may be connected by a series of communication channels provided at different depths with a control system for selecting one or more desired channels during operation.

The reactor system shown in FIG. 5 provides an intensive processing plant for the conduct of high pressure reactions in safety. Additionally, interactivity of reactors provides an ongoing thermal efficiency. Clearly, more than two reactors may be provided in co-operating operation.

Other examples (by no means an exhaustive list) of processes that can use the present invention are:

U.S. Pat. No. 5,312,462 Moist Caustic Leaching of Coal. Coal is slurried in a mixture of NaOH and KOH and heated under pressure to cause a reduction in the levels of ash and sulfur.

U.S. Pat. No. 5,214,015. Synthesis of Iron Based Hydrocracking Catalyst. Iron oxide and sulfur are reacted with a liquid hydrogen donor in the range 180 to 240° C.

U.S. Pat. No. 5,369,214 Method of Selective Dehalogenation of Halogenated Polyaromatic Compounds. Halogenated polaromatic compounds are mixed with a hydrogen donor solvent and a carbon catalyst and pressurised and heated leading to the dehalogenation of the compounds.

U.S. Pat. No. 4,695,372 Conditioning of Carbonaceous Material Prior to Physical Beneficiation. Coal is conditioned by contact with a supercritical fluid (ie typically high temperature and pressure). A minor solute fraction is extracted leading to enhanced beneficiation.

Other examples exist in the fields of achieving phase transformations in solids, leaching, extraction, reaction, polymerisation, liquefaction, oxidation, reduction, processes involving hydrogen donor solvent reactions, dissolution, precipitation.

In some cases, the parent rock material will be suitable to have in contact with the process fluid.

Clearly a very high number of candidate processes can be carried out in the subject system and there are a wide number of variations in the way the underground processing system is assembled and used.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the disclosure.

1. A process arrangement for treating one or more materials, the arrangement comprising one or more vessels located beneath a surface of the ground, the one or more vessels adapted to receive the one or more materials or part thereof, the one or more vessels including a reaction zone, entry means for feeding at least one of the materials to the reaction zone and exit means for retrieving treated material from the reaction zone, wherein:
at least one vessel extends to a depth below the surface sufficient to generate pressure from a hydrostatic head in the entry and/or exit means and the entry means comprises at least two tubes.

2. The process arrangement of claim 1 further comprising two or more vessels located beneath a surface of the ground, each vessel adapted to receive at least one material, the vessels each including a reaction zone, entry means for feeding at least one of the materials to the respective reaction zone and exit means for retrieving treated material from the reaction zone, wherein:
additional vessels extend to a depth below the surface sufficient to generate pressure from a hydrostatic head in the entry and/or exit means and at least two of the vessels are adapted for thermal exchange therebetween.

3. The process arrangement of claim 2 wherein at least one of the additional vessels has an entry means comprising at least two tubes.

4. The process arrangement of any preceding claim wherein at least one of the vessels has an entry means comprising an array of tubes having 7 or more tubes.

5. The process arrangement of claim 4 wherein at least one of the vessels has an entry means comprising an array of tubes having 20 or more tubes.

6. The process arrangement of claim 5 wherein at least one of the vessels has an entry means comprising an array of tubes having between 50 and 200 tubes.

7. The process arrangement of claim 5 wherein at least of the vessels has an entry means comprising an array of tubes having more than 200 tubes.

8. The process arrangement of any one of the preceding claims wherein one or more of the vessels extend at least 100 metres below the surface of the ground.

9. The process arrangement of claim 8 wherein one or more of the vessels extend at least 500 metres below the ground surface.

10. The process arrangement of claim 9 wherein the entry means of at least one vessel is formed as continuous tubes.

11. The process arrangement of claim 10 wherein one or more of the continuous tubes have at least part of their side walls formed by rock.

12. The process arrangement of claim 10 wherein one or more of the continuous tube are formed by Interconnected metallic tubular sections.

13. The process arrangement of any one of the preceding claims wherein each of the tubes has a diameter in the range of 250 mm to 100 mm.

14. The processing arrangement of claim 13 wherein each of the tubes has a diameter around 50 mm.

15. The process arrangement of any one of claim 1 to claim 3 wherein the entry means connects the reaction zone to the surface of the ground.

16. The process arrangement of claim 15 wherein the exit means of at least one vessel is formed as a continuous exit tube.

17. The process arrangement of claim 16 wherein the exit tube has at least part of its side walls formed by rock.

18. The process arrangement of claim 16 wherein the exit means of at least one vessel is formed by interconnected tubular sections.

19. The process arrangement of any one of cialm 1 to claim 3 wherein one or more exit means connects the reaction zone to the surface of the ground.

20. The process arrangement of any one of claim 1 to claim 3 wherein the exit means of at least one vessel includes one or more gas collectors.

21. The process arrangement of any one of claim 1 to claim 3 wherein the exit means of at least one vessel includes a choking valve to control the back pressure on the treated material.

22. The process arrangement of any of claim 1 to claim 3 wherein the entry means and exit means are formed in a downwardly directed bore.

23. The process arrangement of claim 22 wherein the bore is substantially vertical.

24. The process arrangement of claim 2 or claim 3 wherein the at least two vessels are in heat exchanging proximity to each other.

25. The process arrangement of claim 24 wherein the at least two vessels are adapted for thermal exchange therebetween through heat exchange means.

26. The process arrangement of claim 25 wherein the heat exchange means is a heat transferring wall section common to at least two vessels.

27. The process arrangement of claim 25 wherein the heat exchange means comprises a liquid located in a circulation system wherein the liquid is circulated into heat exchanging contact with at least two vessels.

28. The process arrangement of either claim 1 or claim 2 further comprising an access shaft adapted to provide access below the surface of the ground to at least one vessel.

29. A reactor assembly comprising at least two reaction chambers each formed with an inlet means for delivering process materials to a reaction zone, an outlet means for retrieving treated process materials or their products from the reaction zone wherein the inlet means and outlet means are located in downwardly extending subterranean passages, at least two of the reaction chambers are adapted for thermal exchange therebetween and the inlet means comprises an array of 50 or more tubes.

30. The reactor assembly of claim 29 wherein one or more of the reactor chambers are formed with an extended U shaped configuration.

31. The reactor assembly of claim 29 wherein one of the reaction chambers is located substantially within the confines of at least one other of the reaction chambers.

32. The reactor assembly of claim 29 wherein the reaction chambers are adapted for thermal exchange through heat exchange means.

33. The reactor assembly of claim 32 wherein the heat exchange means comprises a circulation system for circulating a heat conducting liquid into heat exchanging contact with at least two reaction chambers.

34. The reactor assembly of any one of claims 29 to 33 further comprising one or more subterranean communication channels providing a pathway for fluid in an outlet means of one reaction chamber to transfer to an inlet means of another reaction chamber.

35. A method of conducting two processes under pressurised conditions comprising the steps of:
introducing materials for a first process Into a first reactor located substantially underground and formed by a downwardly extending inlet tube communicating with a processing zone, said processing zone communicating with an upwardly extending outlet tube arrangement:
introducing further materials for a second process into a second reactor located substantially underground and formed by a downwardly extending inlet tube communicating with a processing zone, said processing zone communicating with an upwardly extending outlet tube arrangement,
initiating the first and second processes; and
transferring heat between the reactors wherein one of the processes is hydrothermal dewatering of coal.

36. The method of claim 35 wherein the other of the processes is coal liquefaction.

37. The method of claim 36 wherein coal which has undergone hydrothermal dewatedng in the first process is subject to liquefaction in the second process

38. A method of hydrothermal dewatering of coal in an underground reactor comprising one or more delivery tubes communicating with a reaction chamber which in turn communicates with one or more exit tubes, the method comprising the steps of:
delivering a coal slurry through the one or more delivery tubes to the reaction zone; and
initiating the hydrothermal dewatering process such that the process occurs substantially in conditions of decreasing pressure as the material rises in the one or more exit tubes.

39. The method of claim 38 further including the step of:
maintaining an upward directed flow of the slurry substantially throughout hydrothermal dewatering of the coal.

40. The method of claim 39 wherein the velocity of material is controlled by pump pressure.

41. The method of claim 39 wherein the upward directed flow of the slurry is maintained throughout hydrothermal dewatering of at least 50% of the coal.

42. The method of claim 38 wherein a velocity of the slurry is in the range of 0.5 metre per second to 3 metres per second.

43. The method of claim 42 wherein the velocity is around 1 metre per second.

44. The method of claim 43 wherein a concentration of coal in the slurry is selected to control the heat production of the reaction and thereby control the temperature in the reaction zone.

45. The method of claim 43 wherein the concentration of as mined coal in the slurry is between 40% weight percentage and 65% weight percentage.

46. The method of claim 45 wherein the concentration of coal in the slurry is around 50% weight percentage.

47. The method of any one of claims 39 to 46 wherein the coal is brown coal.
